(19) United States
(12) Patent Application Publication
(10) Pub. No.: US 2022/0178174 A1
(43) Pub. Date: Jun. 9, 2022

(54) TAMPER PROOF WALL MOUNTED STRIKE ASSEMBLY FOR BARN DOOR

(71) Applicant: Qianyan Cheng, Sacramento, CA (US)

(72) Inventor: Qianyan Cheng, Sacramento, CA (US)

(21) Appl. No.: 17/111,894

(22) Filed: Dec. 4, 2020

(51) Int. Cl. E05B 65/08; E05B 15/02; E05B 63/12

(52) U.S. Cl. CPC E05B 65/0864; E05Y 2900/132; E05B 63/126; E05B 15/022

(57) ABSTRACT

Tamper proof wall mounted strike assembly for barn door is a strike or strike assembly that attaches to a wall or a door molding and functions with a lockset installed on a barn door. Tamper proof wall mounted strike assembly functions to receive the latch or deadbolt from the door lockset on the barn door wherein the latch or deadbolt can be latched or locked within the strike assembly to latch and/or lock the barn door and the latch or the deadbolt can be unlatched or unlocked within the strike assembly to unlatch and/or unlock the barn door. Tamper proof wall mounted strike assembly includes a strike housing assembly that mates with a wall plate assembly by interlocking teeth on each assembly to yield a tamper proof connection there between that is without any exposed screws or fasteners when the barn door is in the closed position to yield a tamper proof wall mounted strike assembly.

### BACKGROUND OF THE INVENTION

### 1. Field of the Invention

This invention relates to a strike or a strike assembly for a door lockset and more specifically to a special strike assembly that attaches to a wall or a door molding and functions with a lockset installed on a barn door. A barn door is attached to the outside of a doorway on the wall and slides back and forth to open and close the door. The special strike assembly of this invention functions to receive the latch or the deadbolt from the door lockset on the barn door wherein the latch or deadbolt can be latched or locked within the special strike assembly to latch and/or lock the barn door and the latch or the deadbolt can be unlatched or unlocked within the special strike assembly to unlatch and/or unlock the barn door.

### 2. Description of Related Art

There are other strikes or strike assemblies for barn doors in the prior art however there are none as shown and described here that include a special strike housing assembly that mates with a special wall plate assembly by interlocking teeth on each assembly to yield a tamper proof connection there between that is without any exposed screws or fasteners when the barn door is in the closed position to yield a tamper proof wall mounted strike assembly.

### BRIEF SUMMARY OF THE INVENTION

It is an aspect of tamper proof wall mounted strike assembly for barn door to include a special strike housing assembly with a tooth plate that mates with a special wall mount assembly with another tooth plate wherein the two tooth plates mate and interlock with each other.

It is an aspect of special strike housing assembly to include a rigid hollow rectangular cuboid member that functions to receive the latch or deadbolt from the door lockset and to retain or lock the latch or deadbolt therein in order to latch or lock the barn door.

It is an aspect of special strike housing assembly to include a strike housing tooth plate with a plurality of teeth or merlons with each separated by a crenel.

It is an aspect of special wall mount assembly to include a wall plate, a tooth spacer plate, and a wall mounted tooth plate with a plurality of teeth or merlons with each separated by a crenel.

It is an aspect of strike housing tooth plate to attach to a strike housing.

It is an aspect of wall mounted tooth plate to attach to wall plate, tooth spacer plate, and to strike housing.

It is an aspect of strike housing tooth plate and wall mounted tooth plate to interlock with each other to form a locked connection there between.

It is an aspect of tamper proof wall mounted strike assembly for barn door to allow for an attached barn door assembly to close and latch or lock therein without any exposed screws or fasteners thereby making the tamper proof wall mounted strike assembly for barn door tamper proof and tamper resistant.

### BRIEF DESCRIPTION OF THE DRAWINGS

FIG. 1 is a perspective view of tamper proof wall mounted strike assembly for barn door along with an assembly view of tamper proof wall mounted strike assembly for barn door.

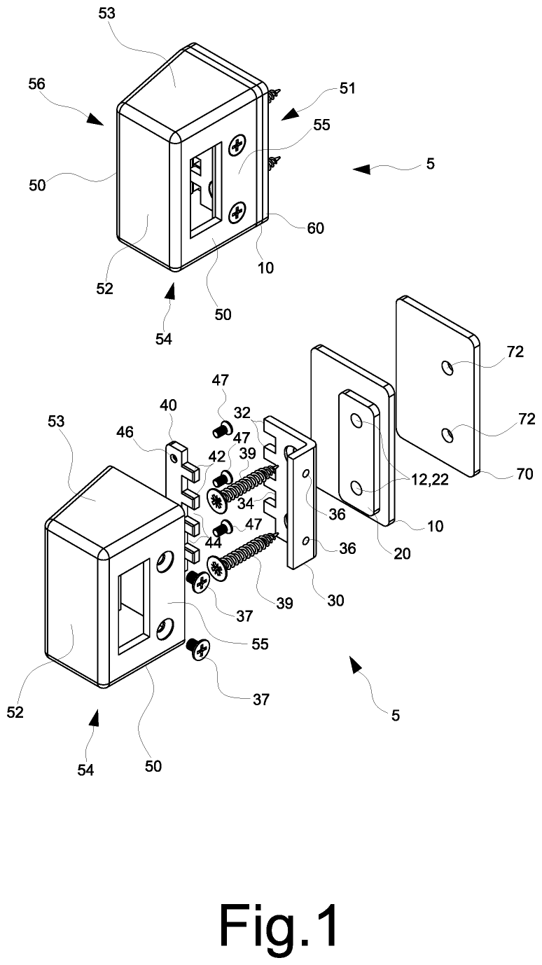

FIG. 2 is a perspective view of strike housing without strike housing tooth plate attached thereto.

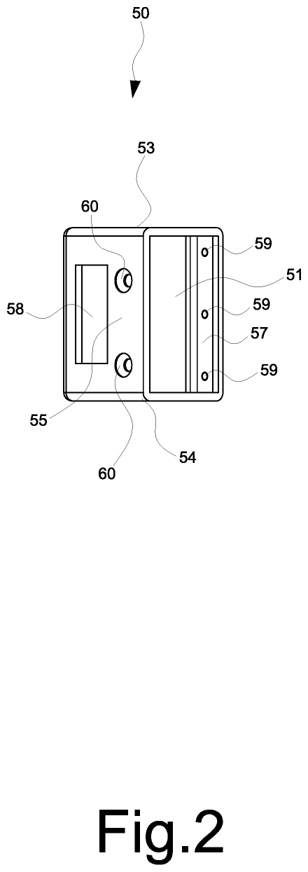

FIG. 3 is a plan view of the wall side of strike housing tooth plate.

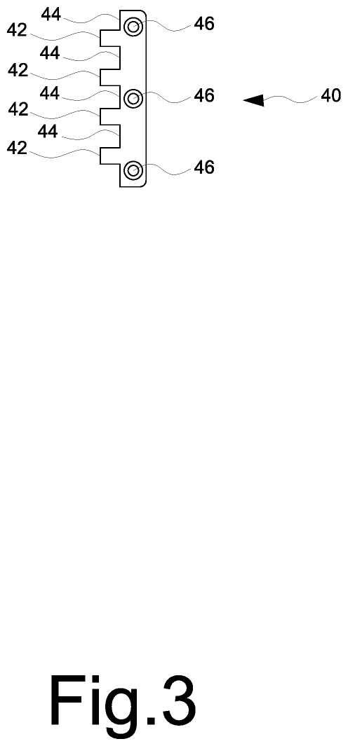

FIG. 4 is a plan view of the room side of strike housing tooth plate.

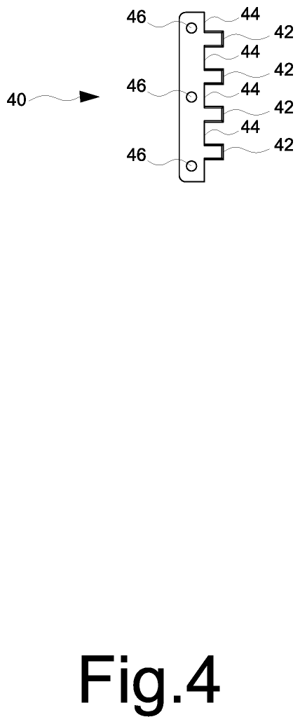

FIG. 5 is a perspective view of the room side of wall mounted tooth plate.

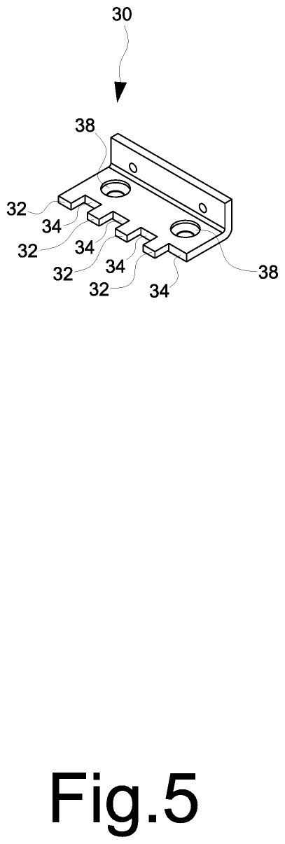

FIG. 6 is a perspective view of the wall side of wall mounted tooth plate.

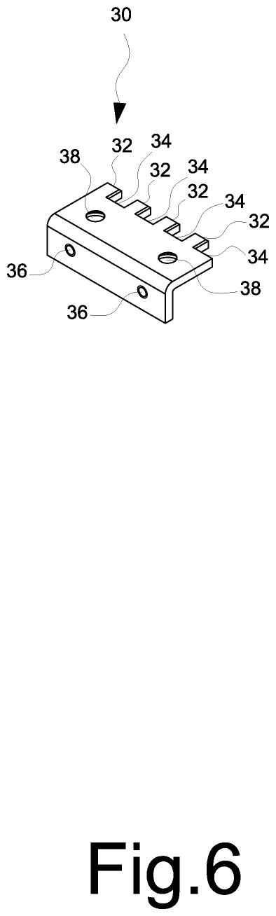

FIG. 7 is a plan view of the room side of tooth spacer plate rigidly attached to wall plate.

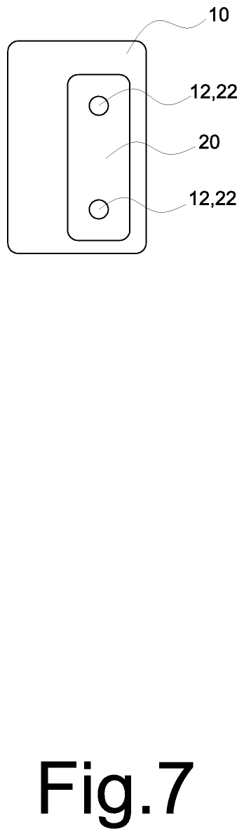

FIG. 8 is a plan view of the door side of tooth spacer plate rigidly attached to wall plate.

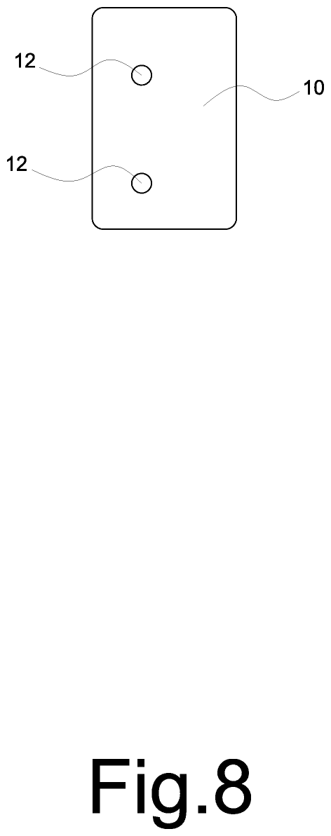

FIG. 9 is an end view of the wall side of strike housing with strike housing tooth plate attached to strike housing.

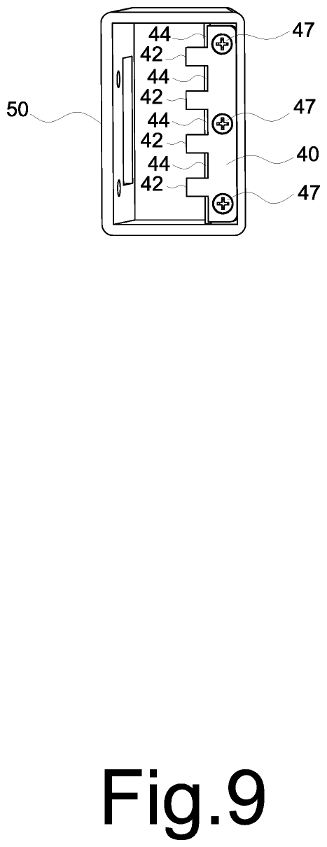

FIG. 10 is a plan view of the room side of wall mounted tooth plate rigidly attached to tooth spacer plate and wall plate.

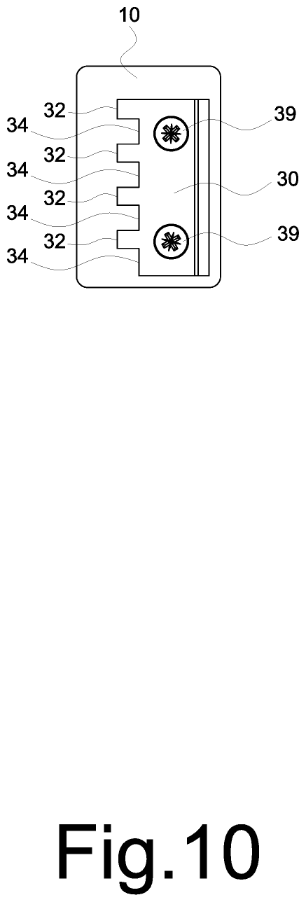

FIG. 11 is an end view of the wall side of strike housing depicting how the teeth of wall mounted tooth plate mesh with, align with, or pass through the crenels of strike housing tooth plate and the teeth of strike housing tooth plate mesh with, align with, or pass through the crenels of wall mounted tooth plate in order to start to lock these members together.

FIG. 12 is an end view of the wall side of strike housing depicting how the teeth of strike housing tooth plate slide behind the teeth of wall mounted tooth plate in order to interlock these members together.

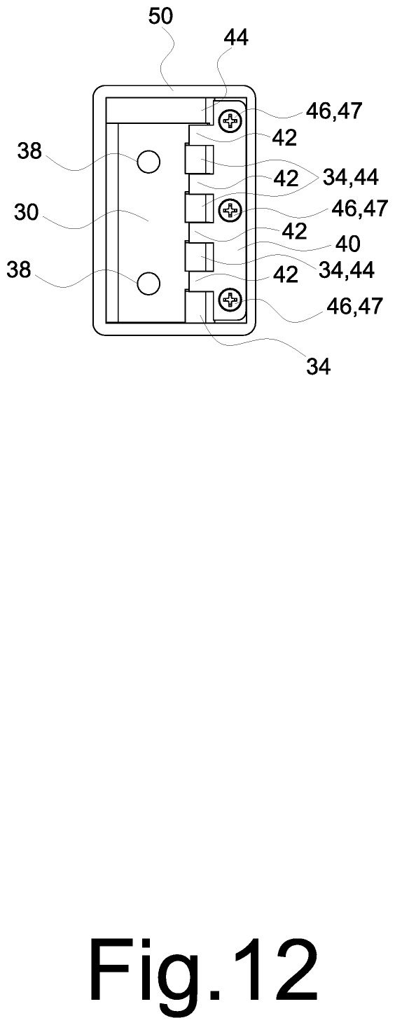

DEFINITION LIST

| Term | Definition |
|---|---|
| 5 | Tamper Proof Wall Mounted Strike Assembly for Barn Door |
| 10 | Wall Plate |
| 12 | Wall Screw Hole in Wall Plate |
| 20 | Tooth Spacer Plate |
| 22 | Wall Screw Hole in Tooth Spacer Plate |
| 30 | Wall Mounted Tooth Plate (WMTP) |
| 32 | Tooth or Merlon on Wall Mounted Tooth Plate |
| 34 | Crenel on Wall Mounted Tooth Plate |
| 36 | Wall Mounted Tooth Plate Screw Hole in WMTP |
| 37 | Wall Mounted Tooth Plate Screw |
| 38 | Wall Screw Hole on Wall Mounted Tooth Plate |
| 39 | Wall Screw |
| 40 | Strike Housing Tooth Plate (SHTP) |
| 42 | Tooth or Merlon on Strike Housing Tooth Plate |
| 44 | Crenel on Strike Housing Tooth Plate |
| 46 | Strike Housing Tooth Plate Screw Hole in SHTP |
| 47 | Strike Housing Tooth Plate Screw |
| 50 | Strike Housing |
| 51 | Wall Side of Strike Housing |
| 52 | Room Side of Strike Housing |
| 53 | First Side of Strike Housing |
| 54 | Second Side of Strike Housing |
| 55 | Door Adjacent Side of Strike Housing |
| 56 | Door Opposite Side of Strike Housing |
| 57 | Tooth Plate Mounting Surface |
| 58 | Deadbolt/Latch Clearance Hole in Strike Housing |
| 59 | Strike Housing Tooth Plate Screw Hole in Strike Housing |
| 60 | Wall Mounted Plate Screw Hole in Strike Housing |
| 70 | Wall Spacer Plate |
| 72 | Wall Screw Hole in Wall Spacer Plate |

### DETAILED DESCRIPTION OF THE INVENTION

Tamper proof wall mounted strike assembly for barn door 5 comprises: a wall plate 10; a tooth spacer plate 20; a wall mounted tooth plate 30; a plurality of wall mounted tooth plate screws 37; a plurality of wall screws 39; a strike housing tooth plate 40; a plurality of strike housing tooth plate screws 47; and a strike housing 50. Wall plate assembly comprises: wall plate 10; tooth spacer plate 20; wall mounted tooth plate 30, and a plurality of wall screws 39. Strike housing assembly comprises: strike housing tooth plate 40; strike housing 50; and a plurality of strike housing tooth plate screws 47. Strike housing assembly is reversibly attached to wall plate housing with a plurality of wall mounted tooth plate screws 37.

Wall plate 10 is a solid rigid planar member. Wall plate 10 is rectangular or square shaped with a height and a width. Wall plate 10 has a longitudinal axis, a latitudinal axis, and a longitudinal bisect. Wall plate 10 has a wall surface and a room surface. The wall surface is the surface of the wall plate 10 that is adjacent to the wall when tamper proof wall mounted strike assembly for barn door 5 is properly installed and attached to a wall or wall molding. The room surface is the surface of the wall plate 10 that is adjacent to the room when tamper proof wall mounted strike assembly for barn door 5 is properly installed and attached to a wall or wall molding. Wall plate 10 has a first edge, a second edge, a door adjacent edge, and a door opposite edge. The first edge is the upper edge of wall plate 10 and the second edge is the lower edge of wall plate 10 when tamper proof wall mounted strike assembly for barn door 5 is properly installed for right side opening barn door and vice versa. The door adjacent edge is the edge of wall plate 10 that is adjacent to the barn door when tamper proof wall mounted strike assembly for barn door 5 is properly installed. The door opposite edge is the edge of wall plate 10 that is opposite from the barn door and door adjacent edge when tamper proof wall mounted strike assembly for barn door 5 is properly installed. Wall plate 10 has at least two wall screw holes 12 therein. This labeling convention is used throughout this application for all components of tamper proof wall mounted strike assembly for barn door 5. Each wall screw hole 12 is cylindrical hole through wall plate 10. Each wall screw hole 12 has an inner diameter and a longitudinal axis. The longitudinal axis of each wall screw hole 12 is perpendicular to the plane of wall plate 10. As discussed below, each wall screw hole 12 must align with a wall screw hole 22 in tooth spacer plate 20 and a wall screw hole 38 in wall mounted tooth plate 30 so that one wall screw 39 may pass through each set of aligning holes.

Tooth spacer plate 20 is a solid rigid planar member. Tooth spacer plate 20 is rectangular or square shaped with a height and a width. The height of tooth spacer plate 20 is less than that of wall plate 10. The width of tooth spacer plate 20 is about half of that of wall plate 10. Tooth spacer plate 20 has a longitudinal axis and a latitudinal axis. Tooth spacer plate 20 has a wall surface and a room surface. Tooth spacer plate 20 has a first edge, a second edge, a door adjacent edge, and a door opposite edge. The wall surface of tooth spacer plate 20 is rigidly attached to the room surface of wall plate 10 so that the longitudinal axis of tooth spacer plate 20 is parallel with that of wall plate 10 and the first edge, second edge, door adjacent edge, and door opposite edge of tooth spacer plate 20 are parallel with those of wall plate 10 and do not overlap those of wall plate 10. Rigid attachment may be accomplished by any known means such as: weld, glue, epoxy, adhesive, bolts, screws, rivets, clips, snaps, pins, or fasteners. Tooth spacer plate 20 is positioned to one side or the other in relation to wall plate 10 so that tooth spacer plate 20 is positioned either to one side or the other of the longitudinal bisect of wall plate 10. These members rigidly attached together form the wall plate tooth spacer plate assembly. In best mode, tooth spacer plate 20 is positioned on the door adjacent side of the longitudinal bisect of wall plate 10. In best mode, tooth spacer plate 20 is welded to wall plate 10. Tooth spacer plate 20 has at least two wall screw holes 22 therein. Each wall screw hole 22 is cylindrical hole through tooth spacer plate 20. Each wall screw hole 22 has an inner diameter and a longitudinal axis. The longitudinal axis of each wall screw hole 22 is perpendicular to the plane of tooth spacer plate 20. Each wall screw hole 22 must align with a wall screw hole 12 in wall plate 10 and a wall screw hole 38 in wall mounted tooth plate 30 so that one wall screw 39 may pass through each set of holes.

Wall mounted tooth plate 30 is a solid rigid angle member with an L-shaped profile. Wall mounted tooth plate 30 has a first planar member and a second plane member. Each planar member has a longitudinal axis and a latitudinal axis. Each planar member has a height and a width. Each planar member has a first edge, a second edge, a third edge, and a fourth edge. The height of first planar member is equal to that of second planer member. The width of first planar member is larger than that of second planer member. The width of first planar member is larger than that of tooth spacer plate 20. The height of first planar member is larger than that of tooth spacer plate 20. First planar member has a wall surface and a room surface. Second planar member has a door adjacent surface and a door opposite surface. The third edge of first planer member is rigidly attached to the first edge of second plane member at a right angle to form the L-shaped profile. The longitudinal axes of first and second planar members are parallel and the latitudinal axes of first and second planar members are perpendicular. The second edges of first and second planar members are flush with each other and the fourth edges of first and second planar members are flush with each other. The first edge of the first planar member has a plurality of teeth or merlons 32 and a plurality of crenels 34 wherein each tooth or merlon 32 is separated by a crenel 34. Each tooth or merlon 32 is a rectangular or square shaped member projecting outward from the first edge of the first planar member of wall mounted tooth plate 30. Each tooth or merlon 32 has a height and a width. Each crenel 34 is a rectangular or square shaped notch or void in between each tooth or merlon 32. Each crenel 34 has a height and a width. The width of each tooth or merlon 32 is equal to that of each crenel 34. The width of each tooth or merlon 32 is about 0.125 to 0.5 inches. The height of each crenel 34,44 is slightly larger than that of each tooth or merlon 32,42 to provide clearance space for each tooth or merlon 32,42 to slide through a crenel 34,44 in order to lock the strike housing assembly onto the wall plate assembly as discussed below. The height of each crenel 34 is about 0.1875 to 0.5625 inches. In best mode, there are four teeth or merlons 32 in wall mounted tooth plate 30 as depicted. In best mode, there are four crenels 34 in wall mounted tooth plate 30 as depicted. The first planar member of wall mounted tooth plate 30 has at least two wall screw holes 38 therein. Each wall screw hole 38 is cylindrical hole through first planar member of wall mounted tooth plate 30. Each wall screw hole 38 has an inner diameter and a longitudinal axis. The longitudinal axis of each wall screw hole 38 is perpendicular to the plane of first planar member. Each wall screw hole 38 must align with a wall screw hole 12 in wall plate 10 and a wall screw hole 22 in tooth spacer plate 20 so that one wall screw 39 may pass through each set of holes. Each wall screw hole 38 may be tapered from the room surface side in order to allow clearance space for the head of each wall screw 39 to countersink to be flush with the room surface of the first planar member of wall mounted tooth plate 30. The second planar member of wall mounted tooth plate 30 has at least two wall mounted tooth plate screw holes 36 therein. Each wall mounted tooth plate screw holes 36 is cylindrical hole through second planar member of wall mounted tooth plate 30. Each wall mounted tooth plate screw holes 36 has an inner diameter and a longitudinal axis. The longitudinal axis of each wall mounted tooth plate screw holes 36 is perpendicular to the plane of second planar member. Each wall mounted tooth plate screw hole 36 must align with a wall mounted tooth plate screw hole 60 in strike housing 50 so that one wall mounted tooth plate screw 37 may pass through each set of holes. Each wall mounted tooth plate screw 37 is a screw, bolt, or fastener. Each wall screw 39 is a screw, bolt, or fastener.

Strike housing tooth plate 40 is a solid rigid planar member. Strike housing tooth plate 40 is rectangular or square shaped with a height and a width. The height of strike housing tooth plate 40 is greater than that of wall mounted tooth plate 30. The width of strike housing tooth plate 40 is less than that that of wall mounted tooth plate 30. Strike housing tooth plate 40 has a longitudinal axis and a latitudinal axis. Strike housing tooth plate 40 has a wall edge and a room edge. Strike housing tooth plate 40 has a first edge, a second edge, a door adjacent surface, and a door opposite surface. The room edge of strike housing tooth plate 40 has a plurality of teeth or merlons 42 and a plurality of crenels 44 wherein each tooth or merlon 42 is separated by a crenel 44. Each tooth or merlon 42 is a rectangular or square shaped member projecting outward from the room edge of strike housing tooth plate 40. Each tooth or merlon 42 has a height and a width. Each crenel 44 is a rectangular or square shaped notch or void in between each tooth or merlon 42. Each crenel 44 has a height and a width. The height and width of each tooth or merlon 42 is equal to those of the teeth or merlons 32 on wall mounted tooth plate 30. The height and width of each crenel 44 is equal to those of crenel 34 on wall mounted tooth plate 30. In best mode, there are four teeth or merlons 42 in strike housing tooth plate 40 as depicted. In best mode, there are four crenels 44 in strike housing tooth plate 40 as depicted. Strike housing tooth plate 40 has at least two strike housing tooth plate screw holes 46 therein. A strike housing tooth plate screw 47 is installed within each strike housing tooth plate screw hole 46 to rigidly attach strike housing tooth plate 40 to strike housing 50. Each strike housing tooth plate screw hole 46 is cylindrical hole through strike housing tooth plate 40. Each strike housing tooth plate screw hole 46 has an inner diameter and a longitudinal axis. The longitudinal axis of each strike housing tooth plate screw hole 46 is perpendicular to the plane of strike housing tooth plate 40. Each strike housing tooth plate screw hole 46 must align with a strike housing tooth plate screw hole 59 in strike housing 50 so that one strike housing tooth plate screw 47 may pass through each set of holes. Each strike housing tooth plate screw hole 46 must be tapered from the door adjacent surface side in order to allow clearance space for the head of each strike housing tooth plate screw 47 to countersink to be flush with the door adjacent surface of strike housing tooth plate 40. The head of each strike housing tooth plate screw 47 must be flush so that the door opposite surface of wall mounted tooth plate 30 may freely slide without obstruction or interference from the head of each strike housing tooth plate screw 47 along the door adjacent surface of strike housing tooth plate 40 in order to lock the strike housing assembly to the wall plate housing assembly, as discussed below. Each strike housing tooth plate screw 47 is a screw, bolt, or fastener. Strike housing 50 is a rigid hollow rectangular cuboid shaped member or box shaped member with six sides. Strike housing 50 has a wall side 51, a room side 52, a first side 53, a second side 54, a door adjacent side 55, and a door opposite side 56. Wall side 51 is the side of strike housing 50 that is adjacent to the wall when tamper proof wall mounted strike assembly for barn door 5 is properly installed and attached to a wall or wall molding. Room side 52 is the side of strike housing 50 that is adjacent to the room when tamper proof wall mounted strike assembly for barn door 5 is properly installed and attached to a wall or wall molding. First side 53 is the upper side of strike housing 50 and second side 54 is the lower side of strike housing 50 when tamper proof wall mounted strike assembly for barn door 5 is properly installed for right side opening barn door and vice versa. Door adjacent side 55 is the side of strike housing 50 that is adjacent to the barn door when tamper proof wall mounted strike assembly for barn door 5 is properly installed. Door opposite side 56 is the side of strike housing 50 that is opposite from the barn door and door adjacent side 55 when tamper proof wall mounted strike assembly for barn door 5 is properly installed. Wall side 51 is open and effectively non-existent. Wall side 51 is open in order to allow strike housing 50 to slide over the wall plate assembly and latch thereto to effectuate a tamper proof rigid connection or attachment therewith as discussed below. The strike housing tooth plate 40 on strike housing assembly interlocks with the wall mounted tooth plate 30 on the wall plate assembly to effectuate a tamper proof rigid connection or attachment therewith as discussed below. There is a tooth plate mounting surface 57 that is a recessed mounting surface just inside of wall side 51. Tooth plate mounting surface 57 is a rigid planar surface recessed inside of the wall side 51 of strike housing 50. The plane of tooth plate mounting surface 57 is parallel with the plane of wall side 51. Tooth plate mounting surface 57 functions as a mounting surface to rigidly attach strike housing tooth plate 40 thereto. Strike housing tooth plate 40 is rigidly attached to tooth plate mounting surface 57 on strike housing 50. Rigid attachment may be accomplished by any known means such as: weld, glue, epoxy, adhesive, bolts, screws, rivets, clips, snaps, pins, or fasteners. In best mode, tooth plate mounting surface 57 includes a plurality of strike housing tooth plate screw holes 59. This is the strike housing assembly. Each strike housing tooth plate screw hole 59 has an inner diameter and a longitudinal axis. The longitudinal axis of each strike housing tooth plate screw hole 59 is perpendicular to the plane of tooth plate mounting surface 57. Each strike housing tooth plate screw hole 59 is a cylindrical hole with female helical thread cut into the inner diameter of the cylindrical hole. Female helical thread is sized to mate with the male cylindrical thread on strike housing tooth plate screws 47. Strike housing tooth plate screws 47 and strike housing tooth plate screw holes 59 function in tandem to reversibly rigidly attach strike housing tooth plate 40 to tooth plate mounting surface 57. Room side 52, first side 53, second side 54, and door opposite side 56 are each a rigid planar member that completely cover their respective side to make a completely closed side of the rectangular cuboid shaped member or box shaped member. In best mode, door opposite side 56 does not make an exact right angle with its four adjacent sides of the rectangular cuboid shaped member or box shaped member but rather is slightly askew to the four adjacent sides to make a trapezoidal shape on that side. Thus, in best mode, strike housing 50 is a rectangular cuboid shape on the door adjacent side and a trapezoidal cuboid shape on the door opposite side as depicted. Door adjacent side 55 is a rigid planar member with a deadbolt/latch clearance hole 58 and a plurality of wall mounted tooth plate screw holes 60. Deadbolt/latch clearance hole 58 is a rectangular or square shaped void or hole through the door adjacent side 55 of strike housing 50. Deadbolt/latch clearance hole 58 functions to provide clearance space for the latch or the deadbolt (not depicted) of the door lockset (not depicted). When the barn door (not depicted) is closed and the door lockset is latched or locked, the latch or the deadbolt of the door lockset moves to catch within deadbolt/latch clearance hole 58 to latch or lock the barn door (not depicted). When the door lockset is latched or locked, the latch or the deadbolt of the door lockset contacts the deadbolt/latch clearance hole 58 to prevent the barn door from opening when the barn door is attempted to be slid open. When the door lockset is unlatched or unlocked, the latch or the deadbolt of the door lockset moves to clear within deadbolt/latch clearance hole 58 to unlatch or unlock the barn door. When the door lockset is unlatched or unlocked, the latch or the deadbolt of the door lockset does not contact the dead bolt/latch clearance hole 58 when the barn door is opened. Each wall mounted tooth plate screw hole 60 is cylindrical hole through door adjacent side 55. Each wall mounted tooth plate screw hole 60 has an inner diameter and a longitudinal axis. The longitudinal axis of each wall mounted tooth plate screw hole 60 is perpendicular to the plane of door adjacent side 55. Each wall mounted tooth plate screw hole 60 must align with a wall mounted tooth plate screw hole 36 in wall mounted tooth plate 30 so that one wall mounted tooth plate screw 37 may pass through each set of holes. Each wall mounted tooth plate screw hole 60 must be tapered from the door adjacent side 55 in order to allow clearance space for the head of each wall mounted tooth plate screw 37 to countersink to be flush with the door adjacent side 55 of strike housing 50. The head of each wall mounted tooth plate screw 37 must be flush so that the barn door may contact the door adjacent side 55 of strike housing 50 when closed without obstruction or interference from the head of each wall mounted tooth plate screw 37.

Tamper proof wall mounted strike assembly for barn door 5 may further comprise one or more wall spacer plates 70. Each wall spacer plate 70 is a solid rigid planar member. Each wall spacer plate 70 is rectangular or square shaped with a height and a width. One or more wall spacer plates 70 function to extend the wall plate assembly from the wall or mount the wall plate assembly further from the wall to allow for proper alignment of the latch or lock from the barn door lockset with the deadbolt/latch clearance hole 58. The latch or lock from the barn door lockset must penetrate the deadbolt/latch clearance hole 58 for the lockset to work properly. Thus, the latch or lock from the barn door lockset must align with the deadbolt/latch clearance hole 58 when the barn door is closed. Barn doors come in a variety of thicknesses so sometimes one or more wall spacer plates 70 are required in order for this alignment to occur. Each wall spacer plate 70 has at least two wall screw holes 72 therein. Each wall screw hole 72 is cylindrical hole through each wall spacer plate 70. Each wall screw hole 72 has an inner diameter and a longitudinal axis. The longitudinal axis of each wall screw hole 72 is perpendicular to the plane of wall spacer plate 70. Each wall screw hole 72 must align with a wall screw hole 12 in wall plate 10, a wall screw hole 22 in tooth spacer plate 20, and a wall screw hole 38 in wall mounted tooth plate 30 so that one wall screw 39 may pass through each set of aligning holes. One or more wall spacer plates 70 are optional and are not an essential component of this invention.

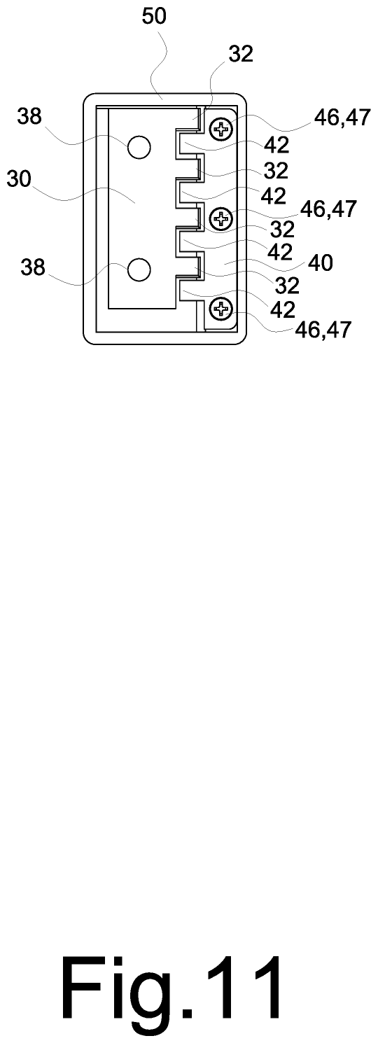

Tamper proof wall mounted strike assembly for barn door 5 is assembled and installed as follows. It is first determined whether the barn door will be right opening or left opening. For a right opening door, the first side 53 of strike housing 50 is the upper end and the second side 54 of strike housing 50 is the lower end. For a left opening door, the second side 54 is the upper end and the first side 53 is the lower end. For a right opening door, the first edge of wall plate 10 is the upper edge and the second edge of wall plate 10 is the lower edge. For a left opening door, the second edge is the upper edge and the first edge is the lower edge. The wall plate tooth spacer plate assembly, comprising the wall plate 10 rigidly attached to the tooth spacer plate 20, is positioned in the proper orientation and location on the wall or door molding. Wall mounted tooth plate 30 is positioned in the proper orientation and location wherein the wall surface of the first planar member of wall mounted tooth plate 30 is adjacent to and in contact with the room surface of tooth spacer plate 20 so the wall screw holes 12,22,38 align with each other. Then one wall screw 39 is installed into each set of aligned wall screw holes 12,22,38 to rigidly attach the wall plate assembly to the wall or door molding. The strike assembly is then aligned with the wall plate assembly so that the teeth or merlons 32 of wall mounted tooth plate 30 mesh with, align with, or pass through the crenels 44 of strike housing tooth plate 40 and the teeth or merlons 42 of strike housing tooth plate 40 mesh with, align with, or pass through the crenels 34 of wall mounted tooth plate 30 in order to start to lock these members together as depicted in FIG. 11. Then the strike assembly is slid upwards for a right opening door and downwards for a left opening door to lock the strike assembly onto the wall assembly by sliding the teeth or merlons 42 of strike housing tooth plate 40 behind the teeth or merlons 32 of wall mounted tooth plate 30 in order to interlock these members together, which also aligns the wall mounted tooth plate screw holes 36 in wall mounted tooth plate 30 with the wall mounted tooth plate screw holes 60 in strike housing 50. Then a wall mounted tooth plate screw 37 is installed within each aligned pair of wall mounted tooth plate screw holes 36,60 to rigidly attach the wall plate assembly to the strike assembly. When barn door is closed and latched or locked, access to wall mounted tooth plate screws 37 is blocked by the barn door. This completes the assembly and installation of tamper proof wall mounted strike assembly for barn door 5.

What is claimed is:

1. A tamper proof wall mounted strike assembly for barn door comprising: a wall plate [10]; a tooth spacer plate [20]; a wall mounted tooth plate [30]; a strike housing tooth plate [40]; and a strike housing [50], wherein
said wall plate [10] is a solid rigid planar member with a height, a width, a longitudinal axis, a latitudinal axis, a longitudinal bisect, a wall surface, a room surface, a first edge, a second edge, a door adjacent edge, a door opposite edge, and at least two wall screw holes [12],
said tooth spacer plate [20] is a solid rigid planar member with a height, a width, a longitudinal axis, a latitudinal axis, a wall surface, a room surface, a first edge, a second edge, a door adjacent edge, a door opposite edge, and at least two wall screw holes [22],
said wall surface of said tooth spacer plate [20] is rigidly attached to said room surface of said wall plate [10],
said wall mounted tooth plate [30] is a solid rigid angle member with an L-shaped profile with a first planar member and a second plane member wherein said first and second planar members each have a height, a width, a longitudinal axis, a latitudinal axis, a first edge, a second edge, a third edge, and a fourth edge,
said third edge of said first planer member is rigidly attached to said first edge of said second plane member at a right angle to form said L-shaped profile,
said first edge of said first planar member has a plurality of teeth or merlons [32] and a plurality of crenels [34] wherein each said tooth or merlon [32] is separated by a said crenel [34],
each said tooth or merlon [32] is a rectangular or square shaped member projecting outward from said first edge of said first planar member of said wall mounted tooth plate [30],
each tooth or merlon [32] has a height and a width,
each said crenel [34] is a rectangular or square shaped notch or void in between each said tooth or merlon [32],
each crenel [34] has a height and a width,
said width of each said tooth or merlon [32] is equal to that of each said crenel [34],
said height of each said crenel [34] is slightly larger than that of each said tooth or merlon [32],
said second planar member of said wall mounted tooth plate [30] has at least two wall mounted tooth plate screw holes [36] therein,
said first planar member of said wall mounted tooth plate [30] has at least two wall screw holes [38] therein,
said strike housing tooth plate [40] is a solid rigid planar member with a height, a width, a longitudinal axis, a latitudinal axis, a wall edge, a room edge, a first edge, a second edge, a door adjacent surface, a door opposite surface,
said room edge of said strike housing tooth plate [40] has a plurality of teeth or merlons [42] and a plurality of crenels [44] wherein each said tooth or merlon [42] is separated by a said crenel [44],
each said tooth or merlon [42] is a rectangular or square shaped member projecting outward from said room edge of said strike housing tooth plate [40],
each said tooth or merlon [42] has a height and a width that are equal to those of said teeth or merlons [32],
each said crenel [44] is a rectangular or square shaped notch or void in between each said tooth or merlon [42],
each said crenel [44] has a height and a width,
said strike housing tooth plate [40] has at least two strike housing tooth plate screw holes [46] therein,
said strike housing [50] is a rigid hollow rectangular cuboid shaped member or box shaped member with a wall side [51], a room side [52], a first side [53], a second side [54], a door adjacent side [55], and a door opposite side [56],
said wall side [51] has a tooth plate mounting surface [57] recessed inside of said wall side [51],
said tooth plate mounting surface [57] is a rigid planar surface with at least two strike housing tooth plate screw holes [59] therein,
said door adjacent side [55] has a deadbolt/latch clearance hole [58] that is a rectangular or square shaped void or hole, and
said door adjacent side [55] has at least two wall mounted tooth plate screw holes [60] therein.

2. A tamper proof wall mounted strike assembly for barn door as recited in claim 1 further comprising: a plurality of strike housing tooth plate screws [47], wherein
each of said plurality of strike housing tooth plate screws [47] is a screw, bolt, or fastener, and
said strike housing tooth plate [40] is rigidly attached to said tooth plate mounting surface [57] with said plurality of strike housing tooth plate screws [47], wherein each of said plurality of strike housing tooth plate screws [47] is installed through each of said at least two strike housing tooth plate screw holes [46] and each of said at least two strike housing tooth plate screw holes [59].

3. A tamper proof wall mounted strike assembly for barn door as recited in claim 2 further comprising: a plurality of wall screws [39], wherein
each of said plurality of wall screws [39] is a screw, bolt, or fastener, and
said wall plate [10], said tooth spacer plate [20], and said wall mounted tooth plate [30] may be rigidly attached to a wall or a door molding with said plurality of wall screws [39], wherein each of said plurality of wall screws [39] is installed through each of said at least two wall screw holes [12], at least two wall screw holes [22], and at least two wall screw holes [38].

4. A tamper proof wall mounted strike assembly for barn door as recited in claim 3 further comprising: a plurality of wall mounted tooth plate screws [37], wherein
each of said plurality of wall mounted tooth plate screws [37] is a screw, bolt, or fastener, and
said wall mounted tooth plate [30] may be rigidly attached to said strike housing [50] with said plurality of wall mounted tooth plate screws [37], wherein each of said plurality of wall mounted tooth plate screws [37] may be installed through each of said at least two wall mounted tooth plate screw holes [36] and each of said at least two wall mounted tooth plate screw holes [60].
